(19) United States
(12) Patent Application Publication
(10) Pub. No.: US 2015/0138789 A1
(43) Pub. Date: May 21, 2015

(54) VEHICLE LIGHTING SYSTEM WITH PHOTOLUMINESCENT STRUCTURE

(71) Applicant: Ford Global Technologies, LLC, Dearborn, MI (US)

(72) Inventors: Jeffrey Singer, Canton, MI (US); Mahendra Somasara Dassanayake, Bloomfield Hills, MI (US); Matthew Majkowski, Dearborn, MI (US); Stuart C. Salter, White Lake, MI (US)

(73) Assignee: Ford Global Technologies, LLC, Dearborn, MI (US)

(21) Appl. No.: 14/086,442

(22) Filed: Nov. 21, 2013

(51) Int. Cl. B60Q 3/02; F21S 8/10

(52) U.S. Cl. CPC B60Q 3/02; F21S 48/00
USPC 362/510

(57) ABSTRACT

A vehicle lighting system is provided and includes a vehicle fixture, an excitation source for emitting at least one inputted electromagnetic radiation, and a photoluminescent structure coupled to the vehicle fixture. The photoluminescent structure includes an energy conversion layer having at least one photoluminescent material formulated to convert the at least one inputted electromagnetic radiation into at least one outputted electromagnetic radiation.

### FIELD OF THE INVENTION

The present invention generally relates to vehicle lighting systems, and more particularly, to vehicle lighting systems employing photoluminescent structures.

### BACKGROUND OF THE INVENTION

Illumination arising from photoluminescent structures offers a unique and attractive viewing experience. It is therefore desired to incorporate such photoluminescent structures in a vehicle lighting system to provide ambient and task lighting.

### SUMMARY OF THE INVENTION

According to one aspect of the present invention, a vehicle lighting system is provided and includes an excitation source including a first blue light emitting diode operable to emit a first inputted electromagnetic radiation having a first peak wavelength, a second blue light emitting diode operable to emit a second inputted electromagnetic radiation having a second peak wavelength, and a third blue light emitting diode operable to emit a third inputted electromagnetic radiation having a third peak wavelength. A photoluminescent structure is coupled to a vehicle fixture and includes an energy conversion layer having a red-emitting photoluminescent material formulated to convert the first inputted electromagnetic radiation into a first outputted electromagnetic radiation, a green-emitting photoluminescent material formulated to convert the second inputted electromagnetic radiation into a second outputted electromagnetic radiation, and a blue-emitting photoluminescent structure formulated to convert the third inputted electromagnetic radiation into a third outputted electromagnetic radiation.

According to another aspect of the present invention, a vehicle lighting system is provided and includes a vehicle fixture, an excitation source for emitting at least one inputted electromagnetic radiation, and a photoluminescent structure coupled to the vehicle fixture. The photoluminescent structure includes an energy conversion layer having at least one photoluminescent material formulated to convert the at least one inputted electromagnetic radiation into at least one outputted electromagnetic radiation.

According to another aspect of the present invention, a vehicle lighting method is provided and includes the steps of providing a photoluminescent structure coupled to a vehicle fixture and including an energy conversion layer having an photoluminescent material, operating an excitation source to emit an inputted electromagnetic radiation for exciting the photoluminescent material, and using the photoluminescent material to convert the inputted electromagnetic radiation into an outputted electromagnetic radiation.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a front passenger compartment of an automotive vehicle having various illuminated fixtures;

FIG. 2 is a perspective view of a rear passenger compartment of the automotive vehicle having various illuminated fixtures;

FIG. 3A illustrates a photoluminescent structure rendered as a coating;

FIG. 3B illustrates the photoluminescent structure rendered as a discrete particle;

FIG. 3C illustrates a plurality photoluminescent structures rendered as discrete particles and incorporated into a separate structure;

FIG. 4 illustrates a vehicle lighting system employing a front-lit configuration;

FIG. 5 illustrates the vehicle lighting system employing a backlit configuration; and

FIG. 6 illustrates a control system of the vehicle lighting system.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a vehicle lighting system in which a vehicle fixture receives a photoluminescent structure for converting a primary emission into a secondary emission generally having a new color. For purposes of this disclosure, a vehicle fixture refers to any interior or exterior piece of vehicle equipment, or part thereof, suitable for receiving the photoluminescent structure described herein. While the implementation of the vehicle lighting system described herein is primarily directed towards automotive vehicle use, it should be appreciated that the vehicle lighting system may also be implemented in other types of vehicles designed to transport one or more passengers such as, but not limited to, watercrafts, trains, and aircrafts.

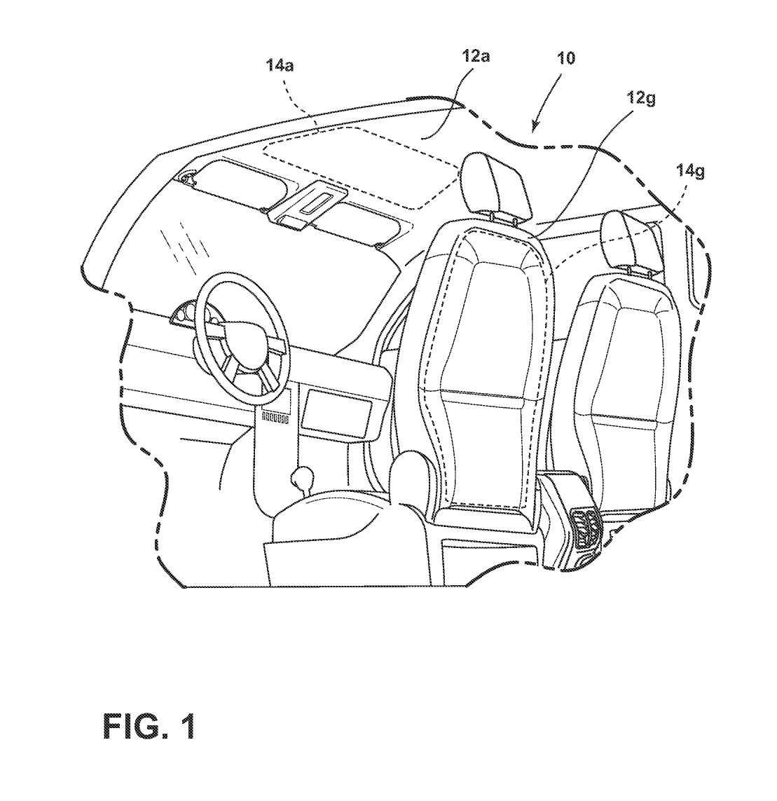

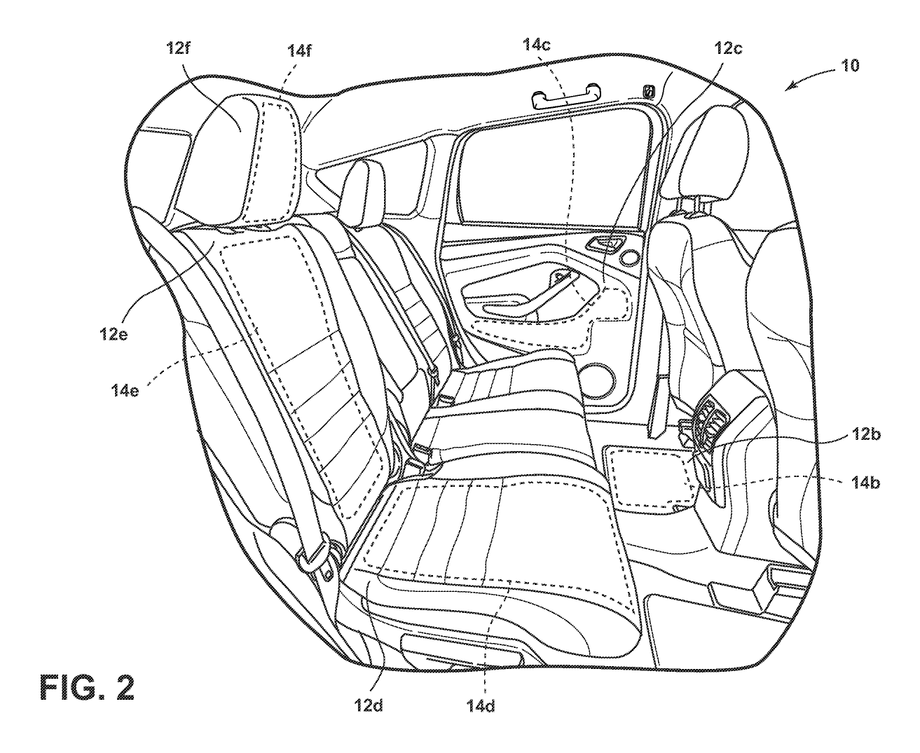

Referring to FIGS. 1 and 2, a passenger compartment 10 of an automotive vehicle is generally shown having a variety of exemplary vehicle fixtures 12a-12g located in the front and rear of the passenger compartment 10. The fixtures 12a-12g generally correspond to a headliner, a floor mat, a door trim panel, and various parts of a seat including a seat base, a backrest, a headrest, and a seat back, respectively. For purposes of illustration, and not limitation, each fixture 12a-12g may receive a photoluminescent structure, further described below, on a selected area 14a-14f of each fixture 12a-12f. With respect to the vehicle lighting system described herein, it should be appreciated that the selected area 12a-12f is not limited to any particular shape or size and may include portions of a fixture having planar and/or non-planar configurations. Although some fixtures 12a-12g have been exemplarily provided, it should be appreciated that other fixtures may be used in accordance with the vehicle lighting system described herein. Such fixtures may include instrument panels and components thereon, interactive mechanisms (e.g. push buttons, switches, dials, and the like), indicating devices (e.g. speedometer, tachometer, etc.), printed surfaces, in addition to exterior fixtures such as, but not limited to, keyless entry buttons, badges, side markers, license plate lamps, trunk lamps, headlights, and tail lights.

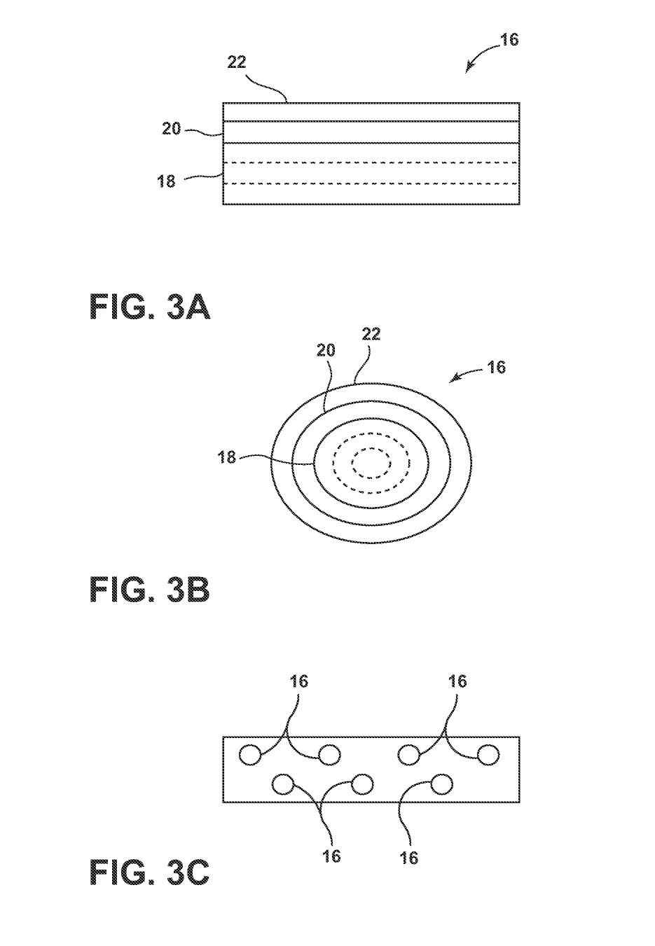

Referring to FIGS. 3A-3C, a photoluminescent structure 16 is generally shown rendered as a coating (e.g. a film) capable of being applied to a vehicle fixture, a discrete particle capable of being implanted in a vehicle fixture, and a plurality of discrete particles incorporated into a separate structure capable of being applied to a vehicle fixture, respectively. At the most basic level, the photoluminescent structure 16 includes an energy conversion layer 18 that may be provided as a single layer or a multilayer structure, as shown through broken lines in FIGS. 3A and 3B. The energy conversion layer 18 may include one or more photoluminescent materials having energy converting elements selected from a phosphorescent or a fluorescent material and formulated to convert an inputted electromagnetic radiation into an outputted electromagnetic radiation generally having a longer wavelength and expressing a color that is not characteristic of the inputted electromagnetic radiation. The difference in wavelength between the inputted and outputted electromagnetic radiations is referred to as the Stokes shift and serves as the principle driving mechanism for the abovementioned energy conversion process, often referred to as down conversion.

The energy conversion layer 18 may be prepared by dispersing the photoluminescent material in a polymer matrix to form a homogenous mixture using a variety of methods. Such methods may include preparing the energy conversion layer 18 from a formulation in a liquid carrier medium and coating the energy conversion layer 18 to a desired planar and/or non-planar substrate of a vehicle fixture. The energy conversion layer 18 coating may be deposited on the selected vehicle fixture by painting, screen printing, spraying, slot coating, dip coating, roller coating, and bar coating. Alternatively the energy conversion layer 18 may be prepared by methods that do not use a liquid carrier medium. For example, a solid state solution (homogenous mixture in a dry state) of one or more photoluminescent materials in a polymer matrix may be converted to the energy conversion layer 18 by extrusion, injection molding, compression molding, calendaring, and thermoforming. In instances where one or more energy conversion layers 18 are rendered as particles, the single or multi-layered energy conversion layers 18 may be implanted into the chosen vehicle fixture instead of applying it as a coating. When the energy conversion layer 18 includes a multilayer formulation, each layer may be sequentially coated, or the layers can be separately prepared and later laminated or embossed together to form an integral layer. Alternatively, the layers may be coextruded to prepare an integrated multi-layered energy conversion structure.

Referring back to FIGS. 3A and 3B, the photoluminescent structure 16 may optionally include at least one stability layer 20 to protect the photoluminescent material contained within the energy conversion layer 18 from photolytic and thermal degradation to provide sustained emissions of outputted electromagnetic radiation. The stability layer 20 may be configured as a separate layer and is optically coupled and adhered to the energy conversion layer 18 or otherwise integrated with the energy conversion layer 16 provided a suitable polymer matrix is selected. The photoluminescent structure 16 may also optionally include a protection layer 22 optically coupled and adhered to the stability layer 20 or other layer to protect the photoluminescent structure 16 from physical and chemical damage arising from environmental exposure.

The stability layer 20 and/or the protective layer 22 may be combined with the energy conversion layer 18 to form an integrated photoluminescent structure 16 through sequential coating or printing of each layer, or by sequential lamination or embossing. Alternatively, several layers may be combined by sequential coating, lamination, or embossing to form a substructure, and the required substructure then laminated or embossed together to form the integrated photoluminescent structure 16. Once formed, the photoluminescent structure 16 may be applied to a chosen vehicle fixture. Alternatively, the photoluminescent structure 16 may be incorporated into the chosen vehicle fixture as one or more discrete multilayered particles. Alternatively still, the photoluminescent structure 16 may be provided as one or more discrete multilayered particles dispersed in a polymer formulation that is subsequently applied to the chosen vehicle fixture as a contiguous structure. Additional information regarding the construction of photoluminescent structures is disclosed in U.S. Pat. No. 8,232,533 entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSIONS,” the entire disclosure of which is incorporated herein by reference.

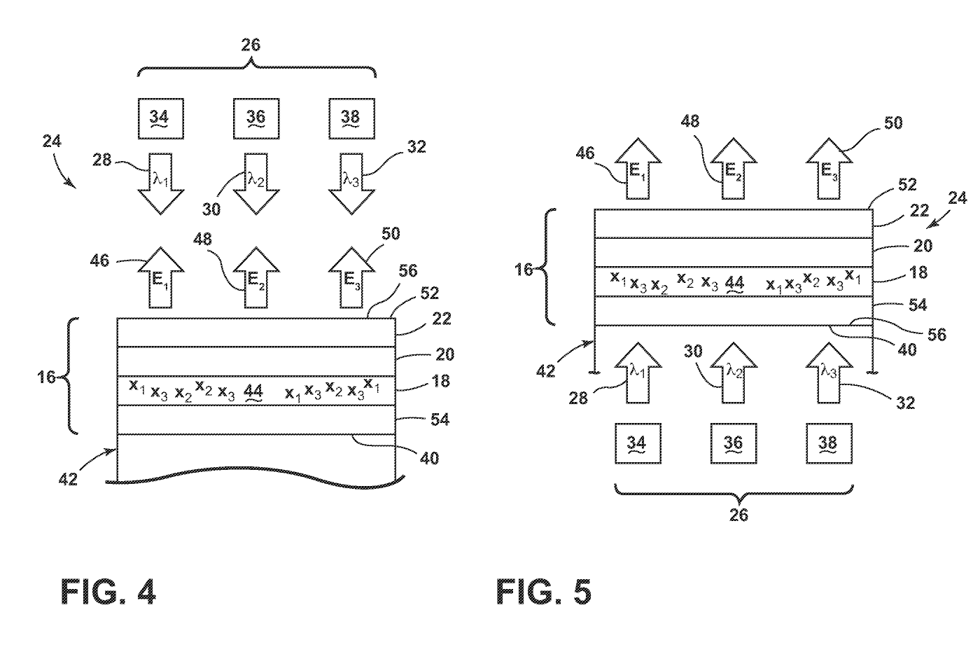

Referring to FIGS. 4 and 5, a vehicle lighting system 24 is generally shown according to a front-lit configuration (FIG. 4) and a backlit configuration (FIG. 5). In both configurations, the vehicle lighting system 24 includes a photoluminescent structure 16 rendered as a coating and applied to a substrate 40 of a vehicle fixture 42. The photoluminescent structure 16 includes an energy conversion layer 18 and optionally includes a stability layer 20 and/or a protective layer 22, as described previously. The energy conversion layer 18 includes a red-emitting photoluminescent material X₁, a green-emitting photoluminescent material X₂, and a blue-emitting photoluminescent material X₃ dispersed in a polymer matrix 44. The red, green, and blue-emitting photoluminescent materials X₁, X₂, and X₃ are chosen because varying mixtures of red, green, and blue light will enable a variety of color sensations to be duplicated. As further described below, an excitation source 26 is operable to excite each of the red, green, and blue-emitting photoluminescent materials X₁, X₂, and X₃ in various combinations to produce different colored light, which is allowed to escape from the photoluminescent structure 16 to provide ambient or task lighting.

The excitation source 26 is generally shown in an external location relative to the photoluminescent structure 16 and is operable to emit a primary emission having a light content defined by a first inputted electromagnetic radiation represented as directional arrow 28, a second inputted electromagnetic radiation represented as directional arrow 30, and/or a third inputted electromagnetic radiation represented as directional arrow 32. The contribution of each inputted electromagnetic radiation 28, 30, 32 in the primary emission depends on an activation state of a corresponding light emitting diode (LED) configured to output light at a unique peak wavelength. In both configurations, the first inputted electromagnetic radiation 28 is emitted from blue LED 34 at a peak wavelength λ₁ selected from a blue spectral color range, which is defined herein as the range of wavelengths generally expressed as blue light (˜450-495 nanometers). The second inputted electromagnetic radiation 30 is emitted from blue LED 36 at a peak wavelength λ₂ also selected from the blue spectral color range and the third inputted electromagnetic radiation 32 is emitted from blue LED 38 at a peak wavelength λ₃ further selected from the blue spectral color range.

By virtue of peak wavelengths λ₁, λ₂, and λ3 having different lengths, blue LEDs 34, 36, and 38 may each be primarily responsible for exciting one of the red, green, and blue-emitting photoluminescent materials X₁, X₂, X₃. Specifically, blue LED 34 is primarily responsible for exciting the red-emitting photoluminescent material X₁, blue LED 36 is primarily responsible for exciting the green-emitting photoluminescent material X₂, and blue LED 38 is primarily responsible for exciting the blue-emitting photoluminescent material X₃. For more efficient energy conversion, the red-emitting photoluminescent material X₁ is selected to have a peak absorption wavelength corresponding to the peak wavelength λ₁ associated with the first inputted electromagnetic radiation 28. When excited, the red-emitting photoluminescent material X₁ converts the first inputted electromagnetic radiation 28 into a first outputted electromagnetic radiation represented as directional arrow 46 and having a peak emission wavelength E₁ that includes a wavelength of a red spectral color range, which is defined herein as the range of wavelengths generally expressed as red light (˜620-750 nanometers). Likewise, the green-emitting photoluminescent material X₂ is selected to have a peak absorption wavelength corresponding to the peak wavelength λ₂ of the second inputted electromagnetic radiation 30. When excited, the green-emitting photoluminescent material X₂ converts the second electromagnetic radiation 30 into a second outputted electromagnetic radiation represented as directional arrow 48 and having a peak emission wavelength E₂ that includes a wavelength of a green spectral color range, which is defined herein as the range of wavelengths generally expressed as green light (˜526-606 nanometers). Lastly, the blue-emitting photoluminecent material X₃ is selected to have a peak absorption wavelength corresponding to the peak wavelength λ₃ of the third inputted electromagnetic radiation 32. When excited, the blue-emitting photoluminescent material X₃ converts the third inputted electromagnetic radiation 32 into a third outputted electromagnetic radiation represented as arrow 50 and having a peak emission wavelength E₃ that includes a longer wavelength of the blue spectral color range.

Given the relatively narrow band of the blue spectral color range, it is recognized that some spectral overlap may occur between the absorption spectrums of the red, green, and blue-emitting photoluminescent materials X₁, X₂, X₃. This may result in the inadvertent excitement of more than one of the red, green, and blue-emitting photoluminescent materials X₁, X₂, X₃ despite only one of the blue LEDs 34, 36, 38 being active, thereby producing unexpected color mixtures. Thus, if desiring greater color separation, the red, green, and blue-emitting photoluminescent materials X₁, X₂, X₃ should be selected to have narrow band absorption spectrums for minimizing any spectral overlap therebetween and peak wavelengths λ₁, λ₂, and λ₃ should be spaced apart to enable sufficient separation between the peak absorption wavelengths of the red, green, and blue-emitting photoluminescent materials X₁, X₂, X₃. In this manner, depending on which of the red, green, and blue-emitting photoluminescent materials X₁, X₂, X₃ are excited, a secondary emission having a more predictable light content may be produced. The secondary emission may express a variety of colors found in a typical RGB color space, including colors that are predominately red, green, blue, or any combination thereof. For example, when blue LEDs 34, 36, and 38 are activated simultaneously, the secondary emission may contain an additive light mixture of red, green, and blue light, which is generally perceived as white light. Other color sensations found in the RGB color space may be produced by activating blue LEDs 34, 36, and 38 in different combinations and/or changing the output intensity associated with the blue LEDs 34, 36, 38 through current control, pulsewidth modulation (PWM), or other means.

Regarding the vehicle lighting system 24 disclosed herein, blue LEDs 34, 36, and 38 are chosen as the excitation source 26 to take advantage of the relative cost benefit attributed therewith when used in vehicle lighting applications. Another advantage of using blue LEDs 34, 36, and 38 is the relatively low visibility of blue light, which may present less of a distraction to a vehicle driver and other occupants in instances where the primary emission must propagate in plain view before reaching the photoluminescent structure 16. Nevertheless, it should be appreciated that the vehicle lighting system 24 may also be implemented using other lighting devices as well as sunlight and/or ambient light. Furthermore, given the range of vehicle fixtures capable of receiving the photoluminescent structure 16, it should also be appreciated that the location of the excitation source 26 will naturally vary depending on the makeup of a particular vehicle fixture and may be external or internal to the photoluminescent structure 16 and/or the vehicle fixture. It should further be appreciated that the excitation source 26 may provide the primary emission directly or indirectly to the photoluminescent structure 16. That is, the excitation source 26 may be positioned such that the primary emission propagates towards the photoluminescent structure 16 or positioned such that the primary emission is distributed to the photoluminescent structure 16 via a light pipe, optical device, or the like.

The energy conversion process used by each of the red, green, and blue-emitting photoluminescent materials X₁, X₂, X₃ described above may be variously implemented given the wide selection of energy conversion elements available. According to one implementation, the energy conversion process occurs through a single absorption/emission event driven by one energy conversion element. For instance, the red-emitting photoluminescent material X₁ may include a phosphor exhibiting a large Stokes shift for absorbing the first inputted electromagnetic radiation 28 and subsequently emitting the first outputted electromagnetic radiation 46. Likewise, the green-emitting photoluminescent material X₂ may also include a phosphor exhibiting a large Stokes shift for absorbing the second inputted electromagnetic radiation 48 and emitting the second outputted electromagnetic radiation. One benefit of using a phosphor or other energy conversion element exhibiting a large Stokes shift is that greater color separation may be achieved between an inputted electromagnetic and an outputted electromagnetic radiation due to a reduction in spectral overlap between the corresponding absorption and emission spectrums. Similarly, by exhibiting a single Stokes shift, the absorption and/or emission spectrums for a given photoluminescent material are less likely to have spectral overlap with the absorption and/or emission spectrums of another photoluminescent material thereby providing greater color separation between the selected photoluminescent materials.

According to another implementation, the energy conversion process occurs through an energy cascade of absorption/emission events driven by a plurality of energy conversion elements with relatively shorter Stokes shifts. For example, the red-emitting photoluminescent material X₁ may contain fluorescent dyes, whereby some or all of the first inputted electromagnetic radiation 28 is absorbed to emit a first intermediate electromagnetic radiation having a longer wavelength and a color that is not characteristic of the first inputted electromagnetic radiation 28. The first intermediate electromagnetic radiation is then absorbed a second time to emit a second intermediate electromagnetic radiation having yet a longer wavelength and a color that is not characteristic of the first intermediate electromagnetic radiation. The second intermediate electromagnetic radiation may be further converted with additional energy conversion elements exhibiting the appropriate Stokes shifts until the desired peak emission wavelength E₁ associated with the first outputted electromagnetic radiation 46 is obtained. A similar energy conversion process may also be observed for the green-emitting photoluminescent material X₂. While energy conversion processes implementing energy cascades may produce broad color spectrums, increasing the number of Stokes shifts may result in less efficient down conversions due to a greater likelihood of spectral overlap between the associated absorption and emission spectrums. In addition, if desiring greater color separation, additional consideration should be exercised such that the absorption and/or emission spectrums of a photoluminescent material have minimal overlap with the absorption and/or emission spectrums of another photoluminescent material also implementing an energy cascade or some other energy conversion process.

Regarding the blue-emitting photoluminescent material X₃, successive conversions of the third inputted electromagnetic radiation 32 via an energy cascade are unlikely to be necessary since the inputted electromagnetic radiation 32 and the outputted electromagnetic radiation 50 are both predisposed to have relatively close peak wavelengths in the blue spectral color range. Thus, the blue photoluminescent material X₃ may include an energy conversion element exhibiting a small Stokes shift. If desiring greater color separation, the blue photoluminescent material X₃ should be selected with an emission spectrum having minimal spectral overlap with the absorption spectrums of the red and green-emitting photoluminescent materials X₁, X₂. Alternatively, an ultraviolet LED may replace blue LED 38 to enable an energy conversion element exhibiting a larger Stokes shift to be used and to provide more flexible spacing opportunities for the emission spectrum of the blue-emitting photoluminescent material X₃ within the blue spectral color range. For front-lit configurations, the photoluminescent structure 16 may alternatively include a narrowband reflective material configured to reflect the third inputted electromagnetic radiation 32 emitted from blue LED 38 in lieu of performing an energy conversion thereto to express blue light, which obviates the need for including the blue-emitting photoluminescent material X₃. Alternatively, the aforementioned reflective material may be configured to reflect a selected amount of the first and second inputted electromagnetic radiations 28, 30 to express blue light, thereby obviating the need for including the blue-emitting photoluminescent material X₃ and blue LED 38. For back-lit configurations, blue light may alternatively be expressed by merely relying on some amount of the third inputted electromagnetic radiation 32 passing through the photoluminescent structure 16, wherein the blue-emitting photoluminescent material X₃ has been omitted.

Since many energy conversion elements are Lambertian emitters, the resulting secondary emissions may be propagated in all directions, including directions pointing away from a desired output surface 52 of the photoluminescent structure 16. As a result, some or all of the secondary emissions may be trapped (total internal reflection) or absorbed by corresponding structures (e.g. the vehicle fixture 42), thereby reducing the luminosity of the photoluminescent structure 16. To minimize the aforementioned phenomenon, the photoluminescent structure 16 may optionally include at least one wavelength-selective layer 54 formulated to redirect (e.g. reflect) wayward propagating secondary emissions towards the output surface 52, which also behaves as an input surface 56 with respect to front-lit configuration shown in FIG. 4. In instances where the input surface 56 and output surface 52 are different, as generally shown by the backlit configuration in FIG. 5, the wavelength-selective layer 54 should readily transmit any primary emissions and redirect any wayward propagating secondary emissions towards the output surface 52.

In both configurations, the wavelength-selective layer 54 is positioned between the substrate 40 and the energy conversion layer 18 so that at least some secondary emissions propagating towards the substrate 40 are redirected towards the output surface 52 to maximize the output of the secondary emission from the photoluminescent structure 16. To this end, the wavelength-selective layer 54 should at the very least be prepared from materials that scatter, but do not absorb, the peak emission wavelengths E₁, E₂, E₃ associated with the first, second, and third outputted electromagnetic radiations 46, 48, 50, respectively. The wavelength-selective layer 54 may be rendered as a coating and is optically coupled to the energy conversion layer 18 and adhered to both the energy conversion layer 18 and the substrate 40 using some of the previously described methods, or other suitable methods.

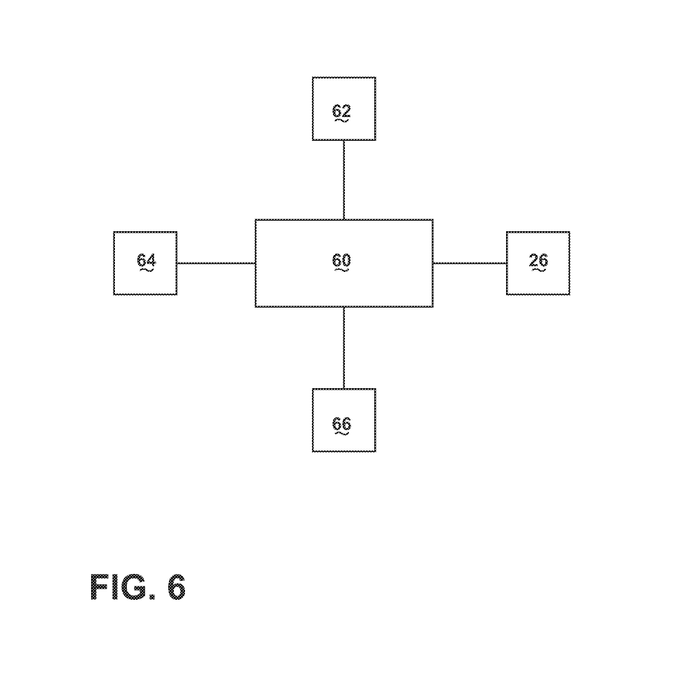

Referring to FIG. 6, the excitation source 26 may be electrically coupled to a processor 60, which provides power to the excitation source 26 via a power source 62 (e.g. onboard vehicle power supply) and controls the operational state of the excitation source and/or the intensity levels of the primary emission of the excitation source 26. Control instructions to the processor 60 may be executed automatically from a program stored within memory. Additionally or alternatively, control instructions may be provided from a vehicle device or system via at least one input 64. Additionally or alternatively still, control instructions may be provided to the processor 60 via any conventional user input mechanism 64, such as, but not limited to, push button, switches, touchscreens, and the like. While the processor 60 is shown electrically coupled to one excitation source 26 in FIG. 6, it should be appreciated that the processor 60 may also be configured to control additional excitation sources using any of the methods described above.

Accordingly, a vehicle lighting system 24 has been described herein. The vehicle lighting system 24 advantageously employs a photoluminescent structure 16 capable of converting a primary emission into a secondary emission to provide a variety of color sensations, thereby enhancing a driving experience and/or general appearance of a vehicle fixture.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle lighting system comprising:
an excitation source including a first blue light emitting diode operable to emit a first inputted electromagnetic radiation having a first peak wavelength, a second blue light emitting diode operable to emit a second inputted electromagnetic radiation having a second peak wavelength, and a third blue light emitting diode operable to emit a third inputted electromagnetic radiation having a third peak wavelength; and
a photoluminescent structure coupled to a vehicle fixture and including an energy conversion layer having a red-emitting photoluminescent material formulated to convert the first inputted electromagnetic radiation into a first outputted electromagnetic radiation, a green-emitting photoluminescent material formulated to convert the second inputted electromagnetic radiation into a second outputted electromagnetic radiation, and a blue-emitting photoluminescent structure formulated to convert the third inputted electromagnetic radiation into a third outputted electromagnetic radiation.

2. The vehicle lighting system of claim 1, wherein the red-emitting photoluminescent material has a first peak absorption wavelength corresponding to the first peak wavelength of the first inputted electromagnetic radiation, the green-emitting photoluminescent material has a second peak absorption wavelength corresponding to the second peak wavelength of the second inputted electromagnetic radiation, and the blue-emitting photoluminescent material has a third peak absorption wavelength corresponding to the third peak wavelength of the third inputted electromagnetic radiation.

3. The vehicle lighting system of claim 1, wherein the red-emitting photoluminescent material has a first peak emission wavelength selected from a red spectral color range, the green-emitting photoluminescent material has a second peak emission wavelength selected from a green spectral color range, and the blue-emitting photoluminescent material has a third peak emission wavelength selected from a blue spectral color range.

4. The vehicle lighting system of claim 1, wherein the red-emitting photoluminescent material includes one of a single energy conversion element exhibiting a large Stokes shift and a plurality of energy conversion elements exhibiting small Stoke shifts for absorbing the first inputted electromagnetic radiation and emitting the first outputted electromagnetic radiation.

5. The vehicle lighting system of claim 1, wherein the green-emitting photoluminescent material includes one of a single energy conversion element exhibiting a large Stokes shift and a plurality of energy conversion elements exhibiting small Stoke shifts for absorbing the second inputted electromagnetic radiation and emitting the second outputted electromagnetic radiation.

6. The vehicle lighting system of claim 1, wherein the blue-emitting photoluminescent material includes a single energy conversion element exhibiting a small Stokes shift for absorbing the third inputted electromagnetic radiation and emitting the third outputted electromagnetic radiation.

7. The vehicle lighting system of claim 1, wherein the excitation source is electrically coupled to a processor for activating at least one of the first, second, and third blue light emitting diodes.

8. The vehicle lighting system of claim 8, wherein the processor controls an output intensity level for each of the first, second, and third blue light emitting diodes.

9. A vehicle lighting system comprising:
a vehicle fixture;
an excitation source for emitting at least one inputted electromagnetic radiation; and
a photoluminescent structure coupled to the vehicle fixture and including an energy conversion layer having at least one photoluminescent material formulated to convert the at least one inputted electromagnetic radiation into at least one outputted electromagnetic radiation.

10. The vehicle lighting system of claim 9, wherein the excitation source comprises a first blue light emitting diode operable to emit a first inputted electromagnetic radiation, a second blue light emitting diode operable to emit a second inputted electromagnetic radiation, and a third blue light emitting diode operable to emit a third inputted electromagnetic radiation.

11. The vehicle lighting system of claim 10, wherein the energy conversion layer comprises a red-emitting photoluminescent material formulated to convert the first inputted electromagnetic radiation into a first outputted electromagnetic radiation and a green-emitting photoluminescent material formulated to convert the second inputted electromagnetic radiation into a second outputted electromagnetic radiation.

12. The vehicle lighting system of claim 11, wherein the photoluminescent structure is configured to reflect the third inputted electromagnetic radiation.

13. The vehicle lighting system of claim 10, wherein the energy conversion layer comprises a red-emitting photoluminescent material formulated to convert the first inputted electromagnetic radiation into a first outputted electromagnetic radiation, a green-emitting photoluminescent material formulated to convert the second inputted electromagnetic radiation into a second outputted electromagnetic radiation, and a blue-emitting photoluminescent material formulated to convert the third inputted electromagnetic radiation into a third outputted electromagnetic radiation.

14. The vehicle lighting system of claim 9, wherein the excitation source comprises a first blue light emitting diode operable to emit a first inputted electromagnetic radiation and a second blue light emitting diode operable to emit a second inputted electromagnetic radiation.

15. The vehicle lighting system of claim 14, wherein the energy conversion layer comprises a red-emitting photoluminescent material formulated to convert the first inputted electromagnetic radiation into a first outputted electromagnetic radiation and the a green-emitting photoluminescent material formulated to convert the second inputted electromagnetic radiation into a second outputted electromagnetic radiation.

16. The vehicle lighting system of claim 15, wherein the photoluminescent structure is configured to reflect a selected amount of the first inputted electromagnetic radiation and the second inputted electromagnetic radiation.

17. The vehicle lighting system of claim 9, wherein the excitation source comprises a first blue light emitting diode operable to emit a first inputted electromagnetic radiation, a second blue light emitting diode operable to emit a second inputted electromagnetic radiation, and an ultraviolet light emitting diode operable to emit a third inputted electromagnetic radiation.

18. The vehicle lighting system of claim 17, wherein the energy conversion layer comprises a red-emitting photoluminescent material formulated to convert the first inputted electromagnetic radiation into a first outputted electromagnetic radiation, a green-emitting photoluminescent material formulated to convert the second inputted electromagnetic radiation into a second outputted electromagnetic radiation, and a blue-emitting photoluminescent material formulated to convert the third inputted electromagnetic radiation into a third outputted electromagnetic radiation.

19. A vehicle lighting method, comprising the steps of:
providing a photoluminescent structure coupled to a vehicle fixture and including an energy conversion layer having an photoluminescent material;
operating an excitation source to emit an inputted electromagnetic radiation for exciting the photoluminescent material; and
using the photoluminescent material to convert the inputted electromagnetic radiation into an outputted electromagnetic radiation.

20. The vehicle lighting method of claim 19, wherein the excitation source comprises a first blue light emitting diode operable to emit a first inputted electromagnetic radiation, a second blue emitting diode operable to emit a second inputted electromagnetic radiation, and a third blue light emitting diode operable to emit a third inputted electromagnetic radiation, wherein the photoluminescent material comprises a red-emitting photoluminescent material formulated to convert the first inputted electromagnetic radiation into a first outputted electromagnetic radiation, a green-emitting photoluminescent material formulated to convert the second inputted electromagnetic radiation into a second outputted electromagnetic radiation, and a blue-emitting photoluminescent material formulated to convert the third inputted electromagnetic radiation into a third outputted electromagnetic radiation.
